(19) United States
(12) Patent Application Publication
(10) Pub. No.: US 2010/0046970 A1
(43) Pub. Date: Feb. 25, 2010

(54) Exposure Head, Method of Controlling Exposure Head, and Image Forming Apparatus

(75) Inventors: Kiyoshi TSUJINO, Matsumoto-shi (JP); Nozomu INOUE, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/544,890

(22) Filed: Aug. 20, 2009

(30) Foreign Application Priority Data
Aug. 21, 2008 (JP) 2008-213230

(51) Int. Cl. G03G 15/043

(52) U.S. Cl. 399/51

(57) ABSTRACT

An exposure head includes: a first light emitting device group including light emitting devices disposed at different positions in a direction perpendicular or approximately perpendicular to a moving direction of an exposed side; a second light emitting device group disposed in the moving direction of the exposed side with respect to the first light emitting device group; an imaging optical system imaging light from the light emitting devices to expose the exposed side; and a control unit allowing one light emitting device group out of either the first light emitting device group or the second light emitting device group to emit light on the basis of a driving signal.

### CROSS-REFERENCE TO RELATED APPLICATIONS

This application claims the benefit of priority under 35 USC 119 of Japanese application no. 2008-213230, filed on Aug. 21, 2008, which is incorporated herein by reference.

### BACKGROUND

1. Technical Field

The present invention relates to an exposure head exposing an exposed side or a latent image holder to light from a light emitting device, a method of controlling the exposure head, and an image forming apparatus employing the exposure head.

2. Related Art

An exposure head has been known which images light from plural light emitting devices by the use of an imaging optical system to expose the surface (exposed side) of the latent image holder. For example, in JP-A-2006-231649, plural light emitting devices are arranged at different positions in a main scanning direction and light from the light emitting devices is imaged by an imaging optical system to form spots at the different positions in the main scanning directions. In this way, a latent image is formed corresponding to one line in the main scanning direction. By allowing the light emitting devices to emit light at a time corresponding to the movement of the surface of the latent image holder in a sub scanning direction perpendicular to the main scanning direction, plural latent images corresponding to the one line are formed in the sub scanning direction to form a two-dimensional latent image.

LED (light Emitting Diodes) or organic EL (Electroluminescence) devices can be employed as the light emitting devices. However, these devices are exhausted due to the repeated emission of light. When the light emitting devices are exhausted and thus cannot emit light with the intensity necessary for forming a latent image, a streaky area in which the latent image is not formed may occur in the sub scanning direction and thus the latent image may not be formed well. In this case, it is necessary to replace the exposure head with a new one. However, the light emitting devices should emit light with the movement of the surface of the latent image holder moving at a high speed so as to cope with the recent requirement for an increase in printing speed and the light emitting devices need to emit light with a higher intensity to satisfactorily form a latent image for a short time. Then, the light emitting devices are more rapidly exhausted due to the increasing of the light intensity of the light emitting devices. As a result, the lifetime of the exposure head is shortened and the operation of replacing the exposure head must be performed frequently, which may cause a great burden on the user.

### SUMMARY

An advantage of some aspects of the invention is that it provides a technique capable of elongating the lifetime of an exposure head to reduce the frequency of the operation of replacing the exposure head.

According to an aspect of the invention, there is provided an exposure head including: a first light emitting device group including light emitting devices disposed at different positions in a direction perpendicular or approximately perpendicular to the moving direction of an exposed side; a second light emitting device group disposed in the moving direction of the exposed side with respect to the first light emitting device group; an imaging optical system imaging light from the light emitting devices to expose the exposed side to the imaged light; and a control unit allowing one light emitting device group out of either the first light emitting device group or the second light emitting device group to emit light on the basis of a driving signal.

According to another aspect of the invention, there is provided a method of controlling an exposure head imaging light from light emitting devices by the use of an imaging optical system to expose an exposed side to the imaged light, in which a first light emitting device group including the light emitting devices disposed at different positions in a direction perpendicular or approximately perpendicular to the moving direction of the exposed side and a second light emitting device group disposed in the moving direction of the exposed side with respect to the first light emitting device group are provided to the exposure head, the method including: allowing one light emitting device group out of either the first light emitting device group or the second light emitting device group to emit light on the basis of a driving signal.

According to another aspect of the invention, there is provided an image forming apparatus including: a latent image holder; an exposure head including a first light emitting device group including light emitting devices disposed at different positions in a direction perpendicular or approximately perpendicular to the moving direction of the latent image holder, a second light emitting device group disposed in the moving direction of the latent image holder with respect to the first light emitting device group, and an imaging optical system imaging light from the light emitting devices to expose the exposed side; and a control unit allowing one light emitting device group out of either the first light emitting device group or the second light emitting device group to emit light on the basis of a driving signal.

In the invention (the exposure head, the method of controlling an exposure head, and the image forming apparatus) having the above-mentioned configurations, the first light emitting device group and the second light emitting device group arranged in the moving direction of the exposed side with respect to the first light emitting device group are provided and one light emitting device group out of either the first light emitting device group or the second light emitting device group emits light on the basis of a driving signal. Therefore, for example, when an exposure operation is repeatedly performed by the use of the first light emitting device group and the light emitting devices of the first light emitting device group are exhausted as a result, the second light emitting device group can be used to continuously perform the formation of latent images. Accordingly, it is possible to continue to perform the exposure operation without replacing the exposure head. In this way, it is possible to elongate the lifetime of the exposure head and to reduce the frequency of the operation of replacing the exposure head.

The light emitting devices may be arranged in a zigzag in the first light emitting device group and the second light emitting device group. This configuration permits a high density arrangement of the light emitting devices, which is advantageous for an increase in resolution of the exposure head.

The invention can be suitably applied to a configuration in which the light emitting devices are organic EL devices. That is, the organic EL device tends to be exhausted more rapidly than an LED device. Therefore, when the invention is applied to the exposure head employing the organic EL device as the light emitting device, it is possible to elongate the lifetime of the exposure head and thus to reduce the frequency of the operation of replacing the exposure head.

In the image forming apparatus including a developing unit disposed in the moving direction of the latent image holder with respect to the exposure head so as to develop a latent image formed on the latent image holder due to the exposure of the exposure head, the control unit may switch the light emitting device group, which is allowed to emit light to expose the latent image holder, in the order of the second light emitting device group and then the first light emitting device group. This configuration provides the following advantage.

That is, a certain time is taken to change the surface of the latent image holder to a necessary potential for the development after being exposed. Accordingly, when the time (exposure-development time) from the exposure of the exposure head to the development of the developing unit is not sufficient, the latent image may not be developed well. On the other hand, the second light emitting device group is disposed closer to the developing unit than the first light emitting device group. Accordingly, when the light emitting device group which is used to emit light for the exposure is switched in the order of the first light emitting device group and then the second light emitting device group, the exposure-development time after the switching is shorter than that before the switching and thus the exposure-development time after the switching may not be sufficient. In this case, it may be considered that the exposure condition of the exposure head or the development condition of the developing unit is set again so as to properly perform the developing operation within the exposure-development time after the switching, but this setting operation takes great labor and thus it is preferable that the setting operation is omitted. On the contrary, by switching the light emitting device group in the order of the second light emitting device group and then the first light emitting device group, it is possible to elongate the exposure-development time after the switching, compared with the exposure-development time before the switching. Accordingly, it is possible to properly perform the exposure operation and the developing operation while omitting the condition setting operation.

Therefore, the control unit may allow the first light emitting device group to emit light under an exposure condition of the exposure head obtained from the latent image formed by the second light emitting device group. The control unit may allow the developing unit to develop the latent image formed by the first light emitting device group under a developing condition of the developing unit obtained from an image which is acquired by allowing the developing unit to develop the latent image formed by the second light emitting device group.

### BRIEF DESCRIPTION OF THE DRAWINGS

The invention will be described with reference to the accompanying drawings, wherein like numbers reference like elements.

FIG. 1 is a diagram illustrating an image forming apparatus according to an embodiment of the invention.

FIG. 2 is a diagram illustrating an electrical configuration of the image forming apparatus shown in FIG. 1.

FIG. 3 is a perspective view illustrating a structure of a line head.

FIG. 4 is a partial sectional view illustrating the structure of a line head.

FIG. 5 is a plan view illustrating a configuration of a light emitting device array disposed on a rear surface of a head substrate.

FIG. 6 is a circuit diagram illustrating a configuration of an emission control circuit controlling the emission of light emitting devices.

FIG. 7 is a flowchart illustrating an example of an operation of switching a light emitting device array.

FIG. 8 is a diagram illustrating a variation in potential of the surface of a photosensitive drum after exposure.

FIG. 9 is a flowchart illustrating another example of the operation of switching a light emitting device array.

### DESCRIPTION OF EXEMPLARY EMBODIMENTS

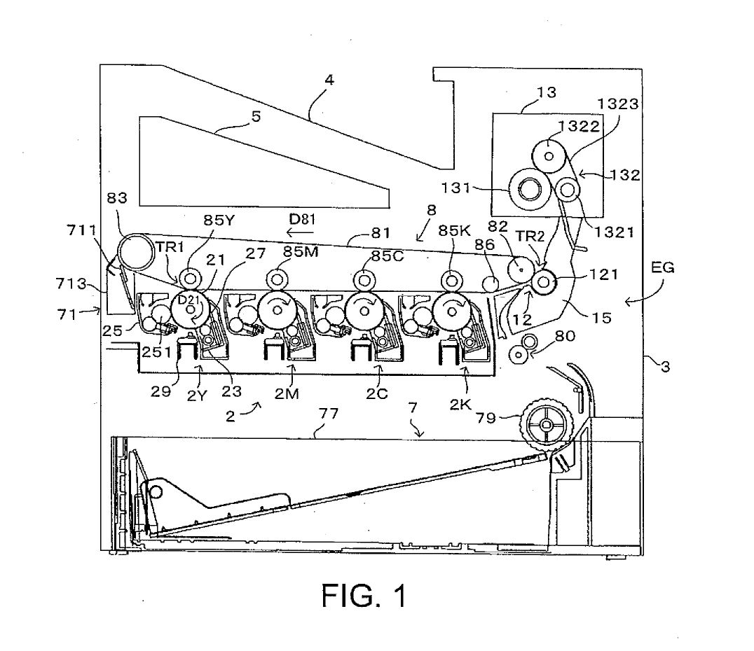

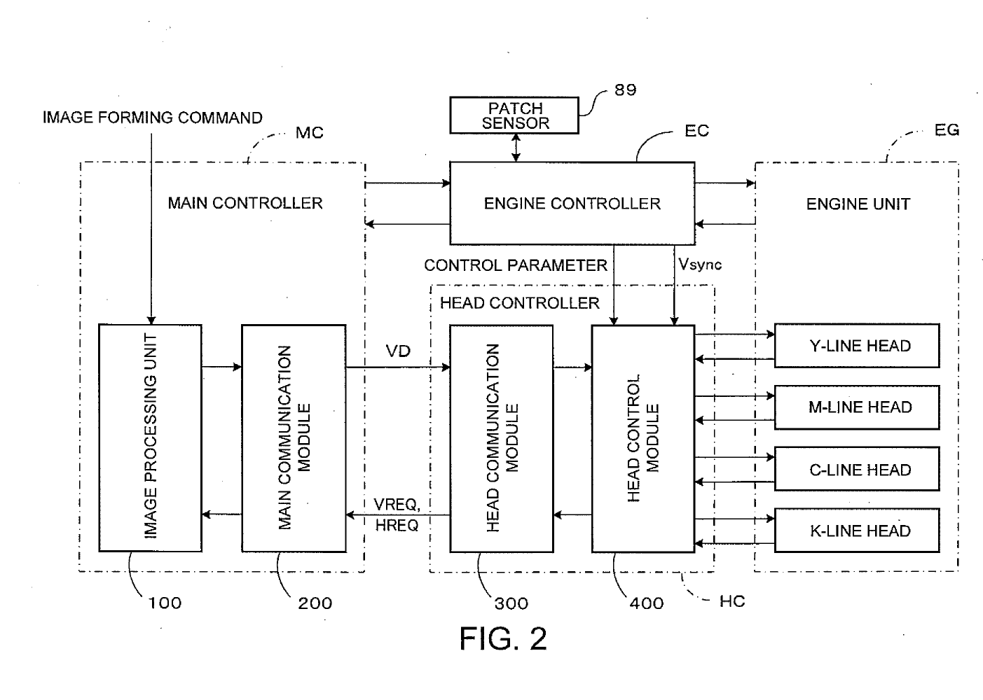

FIG. 1 is a diagram illustrating an image forming apparatus according to an embodiment of the invention. FIG. 2 is a diagram illustrating an electrical configuration of the image forming apparatus shown in FIG. 1. This apparatus is an image forming apparatus capable of selectively operating in a color mode in which a color image is formed in an overlap manner using the four color toners of yellow (Y), magenta (M) cyan (C), and black (K) and a monochrome mode in which a monochromatic image is formed using only the toner of black (K). In the image forming apparatus, when an image forming command is given to a main controller MC including a CPU or a memory from an external apparatus such as a host computer, the main controller MC gives a control signal to an engine controller EC and the engine controller EC controls an engine unit EG and units of the head controller HC on the basis of the control signal to perform a predetermined image forming operation, whereby an image corresponding to the image forming command is formed on a recording sheet such as copying paper, transfer paper, plain paper, and OHP transparent sheet.

A housing body 3 of the image forming apparatus according to this embodiment is provided with an electrical component box 5 having a power supply circuit board, a main controller MC, an engine controller EC, and a head controller HC built therein. An image forming unit 2, a transfer belt unit 8, and a sheet feed unit 7 are disposed in the housing body 3. A secondary transfer unit 12, a fixing unit 13, and a sheet guiding member 15 are disposed on the right side in the housing body 3 in FIG. 1. The sheet feed unit 7 can be attached and detached to and from the housing body 3. The sheet feed unit 7 and the transfer belt unit 8 can be detached to repair or replace them.

The image forming unit 2 includes four image forming stations 2Y (yellow), 2M (magenta), 2C (cyan), and 2K (black) for forming images of different colors. In FIG. 1, since the configurations of the image forming stations of the image forming unit 2 are equal to each other, only some image forming stations are referenced by reference numerals for the purpose of convenient illustration and the other image forming stations are not denoted by reference numerals.

Each image forming station 2Y, 2M, 2C, and 2K is provided with a photosensitive drum 21 in which toner images of each color is formed on the surfaces thereof. The rotation axes of the photosensitive drums 21 are disposed parallel or approximately parallel to a main scanning direction MD (in a direction perpendicular to the drawing sheet of FIG. 1). The photosensitive drums 21 are each connected to exclusive driving motors and are rotationally driven at a predetermined speed in a direction indicated by the arrow D21 in the drawing. Accordingly, the surfaces of the photosensitive drums 21 are transported in a sub scanning direction SD perpendicular or approximately perpendicular to the main scanning direction MD. A charging unit 23, a line head 29, a developing unit 25, and a photosensitive drum cleaner 27 are disposed around each photosensitive drum 21 along the rotation direction thereof. A charging operation, a latent image forming operation, and a toner developing operation are carried out by these functional units. When operating in the color mode, the toner images formed by all the image forming stations 2Y, 2M, 2C, and 2K are made to overlap with a transfer belt 81 disposed in the transfer belt unit 8 to form a color image. When operating in the monochrome mode, only the image forming station 2K is made to operate to form a monochromatic black image.

The charging unit 23 includes a charging roller with a surface formed of elastic rubber. The charging roller comes in contact with the surface of the photosensitive drum 21 at a charging position and follows the rotation of the photosensitive drum 21. That is, the charging roller rotates with the rotation of the photosensitive drum 21. The charging roller is connected to a charging bias generator (not shown), is supplied with a charging bias from the charging bias generator, and charges the surface of the photosensitive drum 21 to a predetermined surface potential at the charging position where the charging unit 23 comes in contact with the photosensitive drum 21.

The line head 29 is disposed so that the longitudinal direction LGD thereof is parallel to or approximately parallel to the main scanning direction MD and the width direction LTD thereof is parallel or approximately parallel to the sub scanning direction SD. The line head 29 includes plural light emitting devices arranged in the longitudinal direction LGD and opposes to the photosensitive drum 21. Light is applied to the surface of the photosensitive drum 21 charged by the charging unit 23 from the light emitting devices to form an electrostatic latent image on the surface thereof.

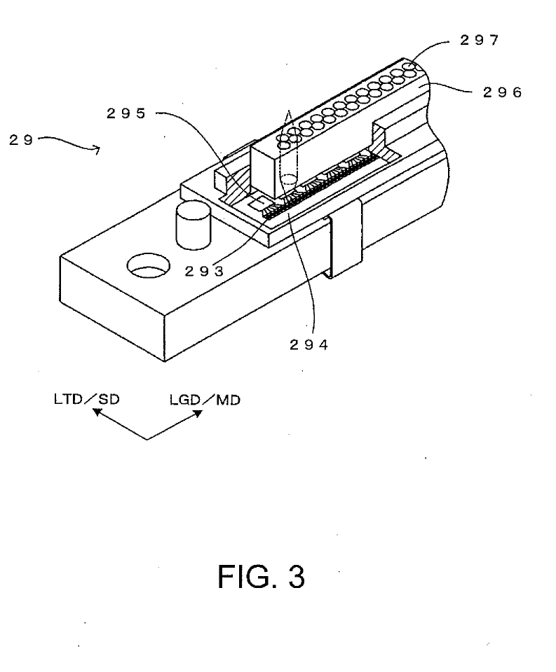

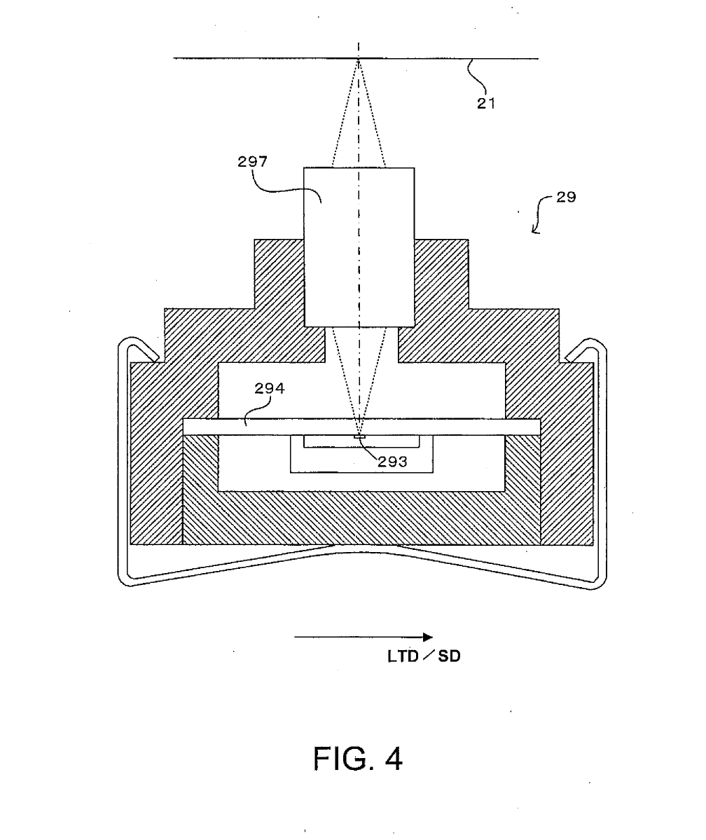

FIG. 3 is a perspective view illustrating a structure of the line head. In the drawing, the rear configuration of a head substrate 294 is shown and the front configuration is omitted. Among the two surfaces of the head substrate 294, the upper surface in the drawing is the front surface and the lower surface in the drawing is the rear surface. FIG. 4 is a partial sectional view illustrating a structure of the line head. The rear surface of the head substrate 294 of the line head 29 is provided with light emitting device arrays 293 in which bottom-emission organic EL devices are formed as light emitting devices E. The rear surface of the head substrate 294 is provided with an emission control circuit 295 (omitted in FIG. 4) allowing the light emitting devices E to emit light on the basis of video data VD. The emission control circuit 295 can be formed of a TFT (Thin Film Transistor). Gradient index rod lens arrays 297 are disposed to correspond to the emission surfaces of the light emitting devices E. Light beams emitted from the light emitting devices E are imaged at the same upright magnification by the gradient index rod lens arrays 297 and thus spots are formed on the surface of the photosensitive drum 21. Accordingly, an electrostatic latent image corresponding to the video data VD is formed on the surface of the photosensitive drum 21.

The configuration of the image forming apparatus will continue to be described with reference to FIG. 1. The developing unit 25 includes a developing roller 251 holding toner on the surface thereof. With the developing bias applied to the developing roller 251 from the developing bias generator (not shown) electrically connected to the developing roller 251, the charged toner moves from the developing roller 251 to the photosensitive drum 21 at a developing position where the developing roller 251 and the photosensitive drum 21 come in contact with each other and thus the electrostatic latent image formed on the surface thereof is developed.

The toner image developed at the developing position is transported in the rotation direction D21 of the photosensitive drum 21 and then is primarily transferred to the transfer belt 81 at a primary transfer position TR1 where the transfer belt 81 to be described in detail later and the photosensitive drum 21 come in contact with each other.

A photosensitive drum cleaner 27 is disposed on the downstream side of the primary transfer position TR1 and the upstream side of the charging unit 23 in the rotation direction D21 of the photosensitive drum 21 so as to come in contact with the surface of the photosensitive drum 21. The photosensitive drum cleaner 27 removes the toner remaining on the surface of the photosensitive drum 21 after the primary transfer, by coming in contact with the surface of the photosensitive drum.

The transfer belt unit 8 includes a driving roller 82, a driven roller 83 (blade-opposing roller) disposed on the left side of the driving roller 82 in FIG. 1, and a transfer belt 81 suspended on the rollers and rotationally driven in the direction of arrow D81 (transport direction) by the rotation of the driving roller 82. The transfer belt unit 8 further includes four primary transfer rollers 85Y, 85M, 85C, and 85K which are disposed inside the transfer belt 81 to correspond respectively to the photosensitive drums 21 of the image forming stations 2Y, 2M, 2C, and 2K at the time of mounting a cartridge. The primary transfer rollers are electrically connected to primary transfer bias generators (not shown).

When operating in the color mode, as shown in FIGS. 1 and 2, the transfer belt 81 is pressed and abutted against the photosensitive drums 21 of the image forming stations 2Y, 2M, 2C, and 2K to form the primary transfer positions TR1 between the photosensitive drums 21 and the transfer belt 81, by positioning all the primary transfer rollers 85Y, 85M, 85C, and 85K at the image forming stations 2Y, 2M, 2C, and 2K. Then, by applying a primary transfer bias to the primary transfer roller 85Y and the like from the primary transfer bias generators at a proper time, the toner images formed on the surfaces of the photosensitive drums 21 are transferred to the surface of the transfer belt 81 at the corresponding primary transfer positions TR1. That is, in the color mode, the monochromatic toner images of the colors overlap with each other on the transfer belt 81 to form a color image.

The transfer belt unit 8 further includes a downstream guide roller 86 disposed on the downstream side of the black primary transfer roller 85K and on the upstream side of the driving roller 82. The downstream guide roller 86 comes in contact with the transfer belt 81 on a common tangential line between the primary transfer roller 85K and the black photosensitive drum 21 (K) at the primary transfer position TR1 formed by bringing the primary transfer roller 85K and the photosensitive drum 21 of the image forming station 2K into contact with each other.

A patch sensor 89 is disposed to face the surface of the transfer belt 81 wound on the downstream guide roller 86. The patch sensor 89 is formed of, for example, a reflecting photo sensor and detects the position or the concentration of a patch image formed on the transfer belt 81 as needed by optically detecting a change in reflectance of the surface of the transfer belt 81.

The sheet feed unit 7 includes a sheet feeder having a sheet feed cassette 77 on which sheets can be piled and maintained, and a pickup roller 79 feeding the sheets one by one from the sheet feed cassette 77. The sheets fed from the sheet feeder by the pickup roller 79 are adjusted in feed time by a registration roller pair 80 and then are fed to a secondary transfer position TR2 where the driving roller 82 and the secondary transfer roller 121 come in contact with each other along the sheet guiding member 15.

The secondary transfer roller 121 is provided to come in contact with and separate from the transfer belt 81, and is driven to come in contact with and separate from by a secondary transfer roller driving mechanism (not shown). The fixing unit 13 includes a heating roller 131 having a heating body such as a halogen heater built therein and able to freely rotate, and a pressing section 132 pressing and pushing the heating roller 131. The sheet having an image secondarily transferred onto the surface thereof is guided to a nip portion formed by the heating roller 131 and a pressing belt 1323 of the pressing section 132 by the use of the sheet guide member 15 and the image is thermally fixed at the nip portion at a predetermined temperature. The pressing section 132 includes two rollers 1321 and 1322 and a pressing belt 1323 suspended thereon. By pressing a belt surface, which is suspended on two rollers 1321 and 1322, out of the surfaces of the pressing belt 1323 against the peripheral surface of the heating roller 131, the nip portion can be formed wide by the heating roller 131 and the pressing belt 1323. The sheet having been subjected to the fixing process is transported to a sheet discharge tray 4 disposed on the top surface of the housing body 3.

The driving roller 82 rotationally drives the transfer belt 81 in the direction of arrow D81 in the drawing and also serves as a backup roller of the secondary transfer roller 121. A rubber layer, with a thickness of about 3 mm and a volume resistivity of 1000 kΩcm or less, is formed on the peripheral surface of the driving roller 82 and is grounded through a metal shaft to form a conductive path of the secondary transfer bias supplied from a secondary transfer bias generator (not shown) via the secondary transfer roller 121. In this way, by providing the rubber layer with high-friction and impact-absorbing characteristics to the driving roller 82, it is possible to prevent deterioration in image quality due to the transmission of an impact onto the transfer belt 81 when the sheet enters the secondary transfer position TR2.

In the apparatus, a cleaner unit 71 is disposed to face the blade-opposing roller 83. The cleaner unit 71 includes a cleaner blade 711 and a waste toner box 713. The cleaner blade 711 removes particles of toner or paper dust remaining on the transfer belt 81 after the secondary transfer by bringing its front end into contact with the blade-opposing roller 83 with the transfer belt 81 interposed there between. The removed particles are collected to the waste toner box 713. The cleaner blade 711 and the waste toner box 713 are formed integrally with the blade-opposing roller 83.

In this embodiment, the photosensitive drum 21, the charging unit 23, the developing unit 25, and the photosensitive drum cleaner 27 of the respective image forming stations 2Y, 2M, 2C, and 2K are formed integrally in a unit as a cartridge. The cartridges can be attached and detached to and from the apparatus body. A non-volatile memory storing information on the corresponding cartridge is provided to each cartridge. Radio communication is made between the engine controller EC and the cartridges. Accordingly, the information on the corresponding cartridge is transmitted to the engine controller EC and information on each memory is updated and stored. The use history of each cartridge or the lifetime of expendables is managed on the basis of the information.

In this embodiment, the main controller MC, the head controller HC, and the line heads 29 are independently constructed as separate blocks and the blocks are connected to each other via serial communication lines. An operation of exchanging data between the blocks will be described with reference to FIG. 2. When an image forming command is given to the main controller MC from an external apparatus, the main controller MC transmits a control signal for starting up the engine unit EG to the engine controller EC. An image processor 100 disposed in the main controller MC performs a predetermined signal process on the image data included in the image forming command and generates video data VD for each toner color.

On the other hand, the engine controller EC having received the control signal starts the initialization and warming-up of the constituent parts of the engine unit EG. When the initialization and the warming-up are finished and in a state where an image forming operation can be carried out, the engine controller EC outputs a synchronization signal Vsync for the triggering of the image forming operation to the head controller HC controlling the line heads 29.

The head controller HC includes a head control module 400 controlling the line heads and a head communication module 300 performing data communication with the main controller MC. On the other hand, the main controller MC also includes a main communication module 200. A vertical request signal VREQ indicating the head of an image corresponding to one page and a horizontal request signal HREQ requesting the video data corresponding to one line of the image are transmitted to the main communication module 200 from the head communication module 300. On the other hand, the video data VD is transmitted to the head communication module 300 from the main communication module 200 in accordance with the request signals. More specifically, when the main communication module receives the horizontal request signal HREQ after receiving the vertical request signal VREQ indicating the head of an image, it sequentially outputs the video data VD each corresponding to one line from the head of the image. The light emitting devices E emit light on the basis of the video data VD.

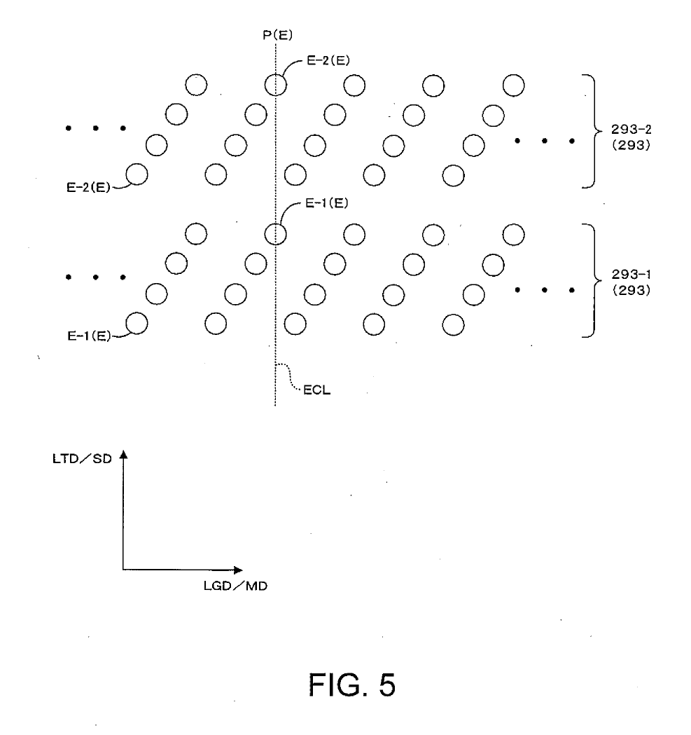

FIG. 5 is a plan view illustrating a configuration of the light emitting device arrays disposed on the rear surface of the head substrate and corresponds to a plan view as the light emitting devices are viewed in the light emitting direction of the light emitting devices E (that is, viewed from the upside in FIGS. 3 and 4). As shown in FIG. 5, in this embodiment, two light emitting device arrays 293-1 and 293-2. are arranged in this order in the sub scanning direction SD. Light emitting devices E are arranged in four lines in a zigzag in each of the light emitting device arrays 293-1 and 293-2. The light emitting devices E-1 of the light emitting device array 293-1 and the light emitting devices E-2 of the light emitting device array 293-2 are arranged to correspond to each other one to one and the two corresponding light emitting devices E-1 and E-2 are arranged in the width direction LTD to form a light emitting device column ECL. In this way, since two light emitting devices E-1 and E-2 forming the light emitting device column ECL are located at the same position P(E) in the main scanning direction MD, they can form a spot in the same area on the surface of the photosensitive drum 21. As described later, one of the light emitting devices E-1 and E-2 out of the light emitting device column ECL selectively emits light, which is provided to form a latent image.

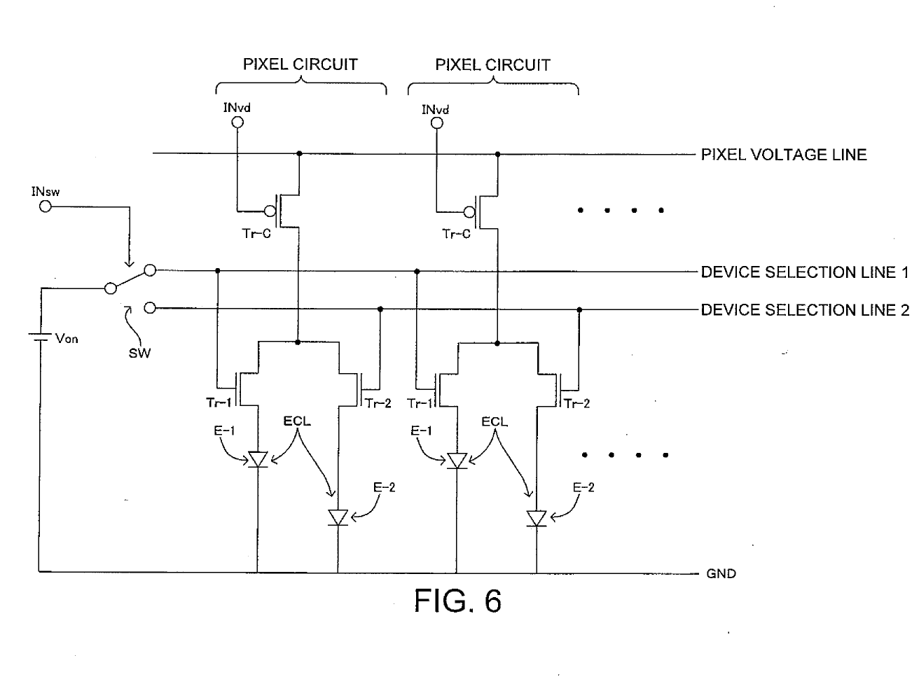

FIG. 6 is a circuit diagram illustrating a configuration of an emission control circuit controlling the emission of light of the respective light emitting devices. As shown in the drawing, a pixel circuit including a constant-current transistor Tr-C and two selection transistors Tr-1 and Tr-2 are disposed in each light emitting device column ECL. The source of the constant-current transistor Tr-C is connected to a pixel voltage line supplying a constant voltage and the gate of the constant-current transistor Tr-C is connected to an input terminal INvd of the video data VD. Therefore, the constant-current transistor Tr-C outputs a driving current corresponding to the video data VD from the drain thereof. The drain of the constant-current transistor Tr-C is connected to the input terminals of the selection transistors Tr-1 and Tr-2 serving as a switch.

Device selecting line 1 is connected to the gate of the selection transistor Tr-1 of the light emitting device array 293-1, and device selecting line 2 is connected to the gate of the selection transistor Tr-2 of the light emitting device array 293-2. Each of the device selecting line 1 and the device selecting line 2 are connected to a constant voltage source via a switch SW and either of the device selecting line 1 and the device selecting line 2 is supplied with an ON voltage from the constant voltage source by switching the switch SW. The output terminal of the selection transistor Tr-1 is connected to the light emitting device E-1 and the output terminal of the selection transistor Tr-2 is connected to the light emitting device E-2. Therefore, by switching the switch SW to device selecting line 1, the driving current is supplied to the light emitting devices E-1 of the light emitting device array 293-1. On the other hand, by switching the switch SW to device selecting line 2, the driving current is supplied to the light emitting devices E-2 of the light emitting device array 293-2.

The switching of the switch SW is performed by the head controller HC. That is, the head controller HC determines which out of the light emitting device arrays 293-1 and 293-2 should perform the exposure operation to form a latent image on the surface of the photosensitive drum 21. Specifically, the switching of the switch SW is performed as follows.

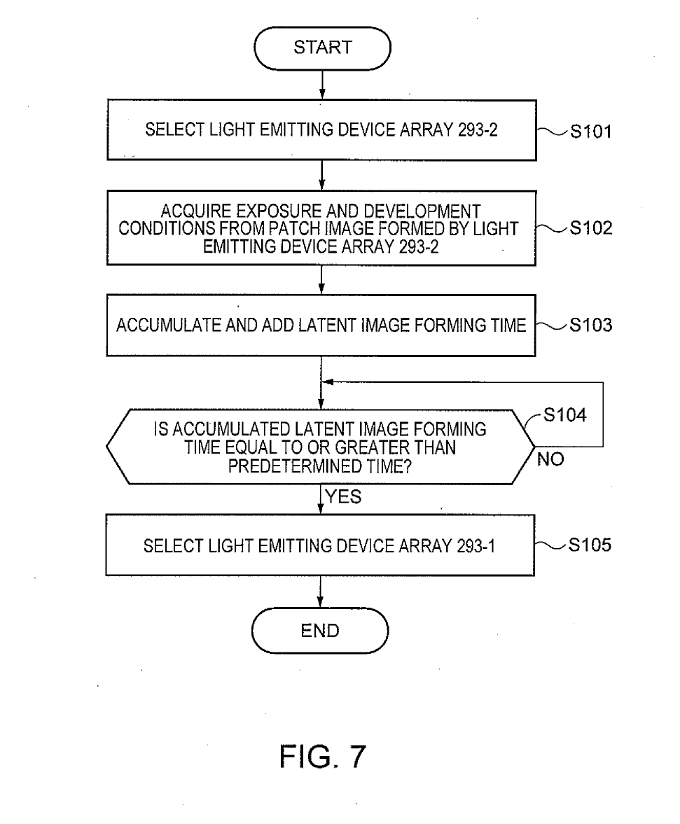

FIG. 7 is a flowchart illustrating an example of an operation of switching the light emitting device array. As shown in the drawing, when the line head 29 forms a latent image in a new product state, the light emitting device array 293-2 is selected and is provided to form the latent image (step S101) In step S102, a latent image corresponding to a patch image is formed using the light emitting device array 293-2 and the latent image is developed by the developing unit 25 to form the patch image. The formed patch image is detected by the patch sensor 89, and the exposure condition of the line head 29 and the development condition of the developing unit 25 are acquired. Various known techniques can be used to acquire the exposure condition and the development condition from the patch image. For example, the technique described in JP-A-2003-270874 can be used. The line head 29 performs the exposure operation under the exposure condition acquired in step S102 and the developing unit 25 performs the developing operation under the development condition acquired in step S102.

The latent image forming time is accumulated and added up every time a latent image is formed (step S103). When the accumulated time for forming latent images is equal to or greater than a predetermined time (Yes in step S104), it is determined that the light emitting device array 293-2 is exhausted and the switch SW is switched (step S105). In this way, the light emitting device array 293-1 is selected and provided to form a latent image.

In this embodiment, the selected light emitting device array 293 of the light emitting device arrays 293-1 and 293-2 emits light on the basis of the video data VD to form a latent image and the non-selected light emitting device array 293 does not emit light and thus does not form a latent image. Therefore, when the light emitting device array 293-2 is repeatedly used to form a latent image and the light emitting devices E-2 of the light emitting device array 293-2 are exhausted as a result, the light emitting device array 293-1 can be selected to continue forming latent images by the use of the light emitting device array 293-1. Accordingly, it is possible to continue to form latent images without replacing the line head 29. Accordingly, in this embodiment, it is possible to elongate the lifetime of the line head 29 and thus to reduce the frequency of the operation of replacing the line head 29.

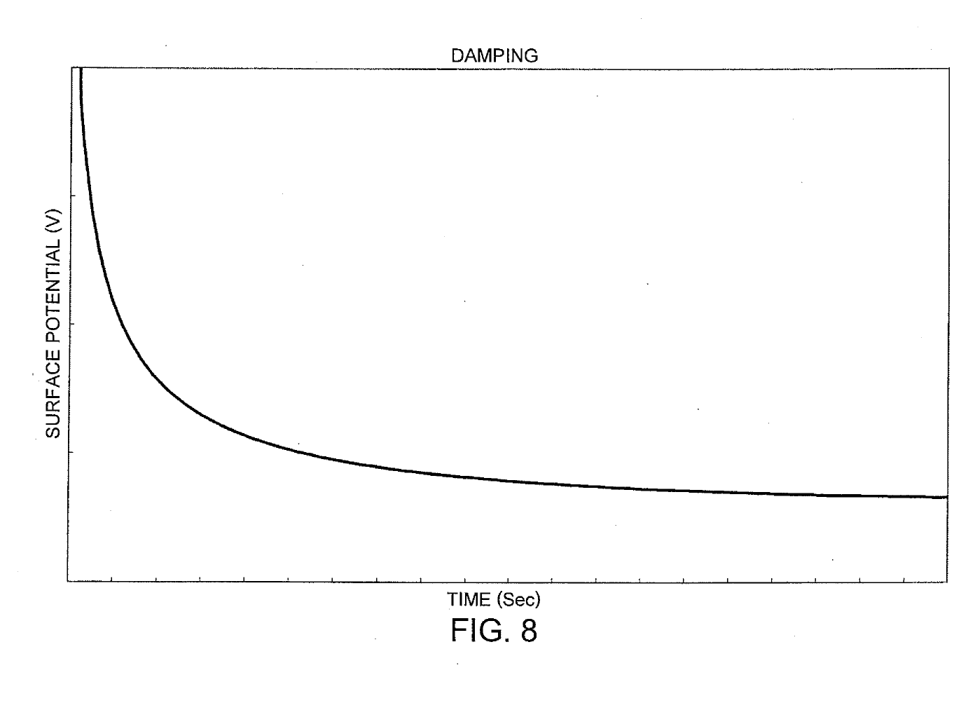

In this embodiment, the light emitting device array 293 used for exposure is switched in the order of the light emitting device array 293-2 and then the light emitting device array 293-1, which provides the following advantage. That is, as shown in FIG. 8, the surface of the photosensitive drum 21 is not neutralized at the same time as the exposure, but exhibits a damping characteristic that the potential thereof decreases over a predetermined time after the exposure. Here, FIG. 8 is a diagram illustrating a variation in the potential of the surface of the photosensitive drum after the exposure, where the horizontal axis represents time (seconds) and the vertical axis represents the surface potential (V) of the photosensitive drum 21. Therefore, a certain amount of time after being exposed is taken to change the surface of the photosensitive drum 21 to the necessary potential for the development. Accordingly, when the time (exposure-development time) from the exposure of the line head 29 to the development of the developing unit 25 is not sufficient, the latent image may not be well developed. On the other hand, the light emitting device array 293-1, the light emitting device array 293-2, and the developing unit 25 are sequentially arranged in the sub scanning direction SD and the light emitting device array 293-2 is disposed closer to the developing unit 25 than the light emitting device array 293-1. Accordingly, when the light emitting device array 293 which is used to emit light for the exposure is switched in the order of the light emitting device array 293-1 and then the light emitting device array 293-2, the exposure-development time after the switching is shorter than that before the switching and thus the exposure-development time after the switching may not be sufficient. In this case, it may be considered that a patch image is formed by the use of the light emitting device array 293-2 and the exposure condition and the development condition are set again so as to properly perform the developing operation within the exposure-development time after the switching, but this setting operation takes great labor and thus it is preferable that the setting operation is omitted.

On the contrary, by switching the light emitting device array in the order of the light emitting device array 293-2 and then the light emitting device array 293-1, it is possible to elongate the exposure-development time after the switching, compared with the exposure-development time before the switching. Accordingly, it is possible to properly perform the exposure operation and the developing operation even when the exposure operation and the developing operation after the switching under the exposure and development conditions acquired in step S102 of FIG. 7 before the switching are performed. Specifically, the exposure operation of the light emitting device array 293-1 after the switching can be performed under the exposure condition acquired in step S102 of FIG. 7 and the developing operation of the developing unit 25 after the switching can be performed under the development condition acquired in step S102 of FIG. 7. Accordingly, it is possible to properly perform the exposure operation and the developing operation while omitting the operation of setting the exposure and development conditions after the switching.

In this embodiment, the light emitting devices E are arranged in a zigzag in the light emitting device arrays 293-1 and 293-2. Accordingly, it is possible to achieve a high density arrangement of the light emitting devices E, which is advantageous for an increase in resolution of the line head 29.

In this embodiment, the line head 29 suitably employs organic EL devices as the light emitting devices. That is, an organic EL device tends to be exhausted more rapidly than an LED device. Therefore, when the invention is applied to the line head 29 employing the organic EL devices as the light emitting devices E, it is possible to elongate the lifetime of the line head 29 and thus to reduce the frequency of the operation of replacing the line head 29.

In this embodiment, the emission control circuit 295 includes a constant-current transistor Tr-C outputting a driving current corresponding to the video data VD and a current supply switching circuit (switch SW and selection transistors Tr-1 and Tr-2) supplying the driving current to the light emitting devices E selected by the head controller HC and not supplying the driving current to the light emitting devices E not selected by the head controller HC. In this configuration, by only switching the destination of the driving current using the current supply switching circuit, the light emitting devices E used to emit light can be simply switched, thereby simplifying the emission control of the light emitting devices E.

In this embodiment, the current supply switching circuit includes a first switch (selection transistor Tr-1) outputting the driving current input to the input terminal thereof from the output terminal connected to the light emitting device E-1 in the ON period of time, a second switch (selection transistor Tr-2) outputting the driving current input to the input terminal thereof from the output terminal connected to the light emitting device E-2 in the ON period of time, and an ON-OFF switching circuit (switch SW) turning on one switch, which is selected by the head controller HC among the first and second switches (selection transistor Tr-1 and selection transistor Tr-2), connected to the light emitting device E and turning off the other switch, which is not selected by the head controller HC connected to the light emitting device E. In this configuration, by only switching the ON and OFF states of the first and second switches (selection transistor Tr-1 and selection transistor Tr-2) by the use of the ON-OFF switching circuit (switch SW), it is possible to simply switch the destination of the driving current, thereby simplifying the switching control of the light emitting devices E.

In this embodiment, the driving current to be supplied to the light emitting devices E-1 and E-2 can be generated by only one constant-current transistor Tr-C, thereby simplifying the configuration.

In the above-mentioned embodiment, the line head 29 corresponds to the “exposure head” in the claims, the gradient index rod lens array 297 corresponds to the “imaging optical system” in the claims, the emission control circuit 295 corresponds to the “control unit” in the claims, the photosensitive drum 21 corresponds to the “latent image holder” in the claims, the surface of the photosensitive drum 21 corresponds to the “exposed side” in the claims, the light emitting device array 293-1 corresponds to the “first light emitting device group” in the claims, the light emitting device array 293-2 corresponds to the “second light emitting device group” in the claims, the video data VD corresponds to the “driving signal” in the claims, and the developing unit 25 corresponds to the “developing unit” in the claims.

The invention is not limited to the above-mentioned embodiment, but may be modified in various forms without departing from the gist of the invention. For example, although the light emitting device array 293 used to form a latent image is switched on the basis of the accumulated time for forming latent images in the above-mentioned embodiment, the light emitting device array 293 used to form a latent image may be switched as follows.

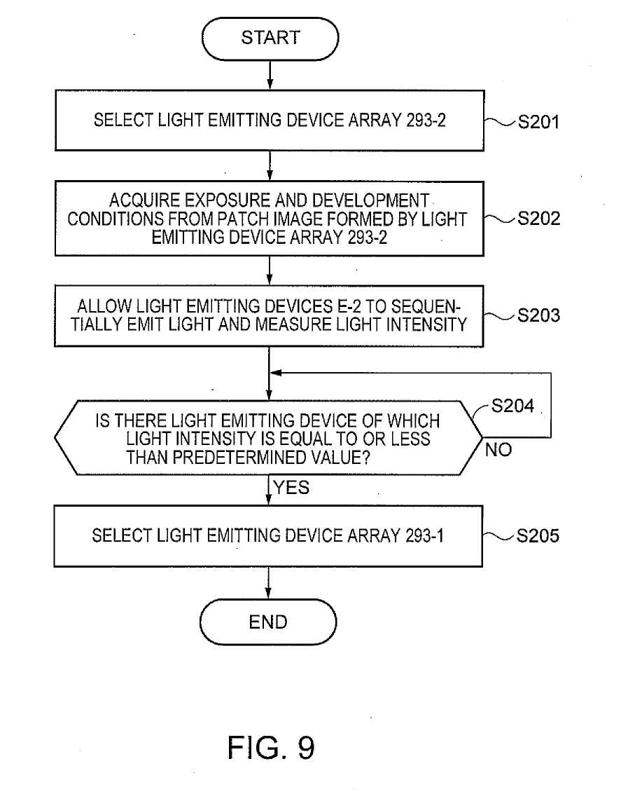

FIG. 9 is a flowchart illustrating another example of the operation of switching the light emitting device array. The above-mentioned embodiment and the example shown in FIG. 9 are similar to each other, in that the light emitting device array 293-2 is provided to form a latent image in the state where the line head 29 is a new product (step S201) and the exposure and development conditions are acquired from the detection result of the patch image formed by the light emitting device array 293-2 (step S202). However, the embodiments are different from each other in view of the following description. In the embodiment shown in FIG. 9, the process of step S203 is performed at a time when latent image is not being formed such as times between formations of the latent images. In step S203, the light emitting devices E-2 of the light emitting device array 293-2 sequentially emit light and the emission intensity is detected by an optical sensor. The optical sensor may be disposed on the surface of the head substrate 294. For example, when the light intensity of a certain light emitting device E-2 is equal to or less than a predetermined value (YES in step S204), it is determined that the light emitting devices B-2 are exhausted. Then, the switch SW is switched in step S205 and the light emitting devices E-1 are provided to form a latent image.

In the above-mentioned embodiment, the light emitting devices E are the organic EL devices, but the light emitting devices E are not limited to the organic EL devices. For example, the light emitting devices E may be LED devices.

In the above-mentioned embodiment, the light emitting devices E are arranged in the four lines in a zigzag in each of the light emitting device array 293, but plural light emitting devices E in two or five or more lines may be arranged in a zigzag or the light emitting devices may be arranged in a single line.

In the above-mentioned embodiment, two light emitting device arrays 293 are arranged in the width direction LTD, but three or more light emitting device arrays 293 may be arranged in the width direction LTD. That is, by selectively using one light emitting device array 293 of the light emitting device arrays 293 arranged in this way to form a latent image, it is possible to elongate the lifetime of the line head 29 and to reduce the frequency of the operation of replacing the line head 29.

Although the light emitting device array 293 used for the exposure is switched in the order of the light emitting device array 295-2 and then the light emitting device array 295-1 in the above-mentioned embodiments, the switching order is not limited to the embodiments.

What is claimed is:

1. An exposure head comprising:
a first light emitting device group including light emitting devices disposed at different positions in a direction perpendicular or approximately perpendicular to a moving direction of an exposed side;
a second light emitting device group disposed in the moving direction of the exposed side with respect to the first light emitting device group;
an imaging optical system imaging light from the light emitting devices to expose the exposed side; and
a control unit allowing one light emitting device group out of either the first light emitting device group or the second light emitting device group to emit light on the basis of a driving signal.

2. The exposure head according to claim 1, wherein the light emitting devices are arranged in a zigzag in the first light emitting device group and the second light emitting device group.

3. The exposure head according to claim 1, wherein the light emitting devices are organic EL devices.

4. A method of controlling an exposure head imaging light from light emitting devices by the use of an imaging optical system to expose an exposed side, in which a first light emitting device group, including the light emitting devices disposed at different positions in a direction perpendicular or approximately perpendicular to a moving direction of the exposed side, and a second light emitting device group disposed in the moving direction of the exposed side with respect to the first light emitting device group are provided to the exposure head, the method comprising:
allowing one light emitting device group out of either the first light emitting device group or the second light emitting device group to emit light on the basis of a driving signal.

5. An image forming apparatus comprising:
a latent image holder;
an exposure head including a first light emitting device group including light emitting devices disposed at different positions in a direction perpendicular or approximately perpendicular to a moving direction of the latent image holder, a second light emitting device group disposed in the moving direction of the latent image holder with respect to the first light emitting device group, and an imaging optical system imaging light from the light emitting devices to expose the latent image holder; and
a control unit allowing one light emitting device group out of either the first light emitting device group or the second light emitting device group to emit light on the basis of a driving signal.

6. The image forming apparatus according to claim 5, further comprising a developing unit developing a latent image formed on the latent image holder due to the exposure of the exposure head,
wherein the control unit switches the light emitting device group, which is allowed to emit light to expose the latent image holder, in the order of the second light emitting device group and then the first light emitting device group.

7. The image forming apparatus according to claim 6, wherein the control unit allows the first light emitting device group to emit light under an exposure condition of the exposure head obtained from the latent image formed by the second light emitting device group.

8. The image forming apparatus according to claim 6, wherein the control unit allows the developing unit to develop the latent image formed by the first light emitting device group under a developing condition of the developing unit obtained from an image which is acquired by allowing the developing unit to develop the latent image formed by the second light emitting device group.
